(19) United States
(12) Patent Application Publication
(10) Pub. No.: US 2015/0248918 A1
(43) Pub. Date: Sep. 3, 2015

(54) SYSTEMS AND METHODS FOR DISPLAYING A USER SELECTED OBJECT AS MARKED BASED ON ITS CONTEXT IN A PROGRAM

(71) Applicant: United Video Properties, Inc., Santa Clara, CA (US)

(72) Inventor: Young A. Tang, Burbank, CA (US)

(21) Appl. No.: 14/194,169

(22) Filed: Feb. 28, 2014

(51) Int. Cl. G11B 27/036; H04N 21/472; H04N 21/8545; H04N 21/41; H04N 21/81; G06F 3/0484; H04N 21/4722

(52) U.S. Cl. CPC G11B 27/036; G06F 3/04842; G06F 3/04845; H04N 21/47205; H04N 21/4722; H04N 21/4126; H04N 21/8126; H04N 21/8545

(57) ABSTRACT

Systems and methods for displaying a user selected object as marked based on its context in a program are discussed herein. In one embodiment, a user selection of an area of a video of a program presented on a second screen may be received. An object in the video corresponding to the selected area may then be identified, as well as an attribute of the object relative to an event in the program. Based on the identified attribute of the object, a manner of marking the object on a first screen that is simultaneously presenting the same video may be selected. The object may then be displayed on the first screen as marked using the selected manner of marking.

### BACKGROUND

A telestrator may receive user input corresponding to lines drawn by a user and, based on this information, overlay such lines onto an image. Telestrators may be useful in annotating images and drawing an observer's attention to a particular feature of the image. For example, a sports announcer might use a telestrator to present the path a player took on an earlier play.

Also, the number and variety of available user equipment devices has proliferated. Any given user may own multiple different types of user equipment devices, some of which may be capable of receiving media content. For example, a user may be able to access the same media asset on a television set, a computer, a tablet or a cellular phone. The user interface displayed on each of these different types of user equipment devices may be the same or may be adapted to leverage the hardware capabilities of each type of user equipment device.

### SUMMARY

In view of the foregoing, systems and methods for selectively transmitting user interaction information based on biometric information are provided. More specifically, in response to a user input selecting an object displayed in a media asset on a first device, a media guidance application may highlight that same object in a display of the media asset on a second device. Furthermore, the media guidance application may customize the highlight on the object on the second device based on the context of the object in the media asset.

For example, a user may be watching the same football game simultaneously on two user devices, for example, a television and a tablet computer. The media guidance application may detect that the user has circled a player in the football game on the tablet computer. In response the media guidance application may determine to highlight the player in the football game presented on the television. In addition, the media guidance application may determine an effect associated with the football player based on the circumstances of the football game. For example, if the player is on offense, the player may appear in a blue highlight, whereas if the player is on defense, the player may appear in a red highlight.

In some aspects, a media guidance application receives a user selection of an area of a video of a program presented on a second screen. The media guidance application may then identify an object in the video corresponding to the selected area, as well as an attribute of the object relative to an event in the program. Based on the identified attribute of the object, the media guidance application may select a manner of marking the object on a first screen that is simultaneously presenting the same video. The object may then be displayed on the first screen as marked using the selected manner of marking.

In some embodiments, the first screen may be connected to a first user equipment device, while the second screen may be connected to a second user equipment device. The first and second user equipment devices may be connected to a network, and each of them may be assigned a different address in the network. The user selection of the area of the second screen may be received over this network from the second user equipment device.

In one embodiment, causing the object to be displayed in a marked manner may involve one or more of causing a border of a particular color to be displayed around the object, causing an indication of a particular shape to be displayed in a position associated with the object, and causing the object to be displayed using a particular color scheme. Selecting the manner of marking the object may then involve selecting one or more of the particular color, the particular shape, and the particular color scheme.

In one embodiment, identifying the attribute of the object relative to the event in the program may involve identifying an action being performed by the object. In another embodiment, identifying the attribute of the object may involve one or more of identifying that the object is a speaker of a current line of dialogue, that the object is a participant in a sporting event who has possession of a piece of equipment associated with this event, that the object is a participant in a sporting event who scored a point, or that the object is a participant in a sporting event who is within a particular region of the venue of the sporting event.

In one embodiment, a second attribute of the object relative to another event in the program may be identified at a later time. This second attribute may be identified without either a second user selection of the previously selected area of the video or a user selection of a different second area of the video. A different second manner of marking the object on the first screen may be selected based on this identified second attribute of the object, and the object may be displayed on the first screen as marked using the different second manner of marking.

In one embodiment, a determination may be made that at a later point in time the object is located in a different second area of the video presented on the first screen. This determination may be made without either a second user selection of the previously selected area of the video or a user selection of the different second area of the video. A determination may also be made that the attribute previously identified is still an attribute of the object relative to the event in the program. The object may then be displayed in the different second area of the first screen using the same previously selected manner of marking.

In one embodiment, receiving the user selection of the area of the video presented on the second screen may involve receiving a set of coordinates corresponding to a border that at least partially surrounds this area.

In one embodiment, additional information associated with the identified object may be displayed on the first screen based on the identified attribute of the object.

It should be noted that the systems and/or methods described above may be applied to, or used in combination with, other systems and/or methods as described below.

### BRIEF DESCRIPTION OF THE DRAWINGS

The above and other features of the present application, its nature and various advantages will become more apparent upon consideration of the following detailed description, taken in conjunction with the accompanying drawings, in which like reference characters refer to like parts throughout, and in which:

FIGS. 1 and 2 show illustrative display screens that may be used to provide media guidance application listings in accordance with some embodiments;

FIG. 3 shows an illustrative user equipment device in accordance with some embodiments;

FIG. 4 is a diagram of an illustrative cross-platform interactive media system in accordance with some embodiments;

FIG. 5 shows two illustrative user equipment devices presenting the same video on two screens in accordance with some embodiments;

FIG. 6 shows two illustrative user equipment devices presenting a video of a program on a second screen and related information on a first screen in accordance with some embodiments;

FIG. 7 shows an illustrative display screen of a video of a program with an object displayed as marked using a manner of marking in accordance with some embodiments;

FIG. 8 shows an illustrative display screen of the video of the program at a later time with the object displayed as marked using a different second manner of marking in accordance with some embodiments;

FIG. 9 shows an illustrative display screen of a video of a program with an object displayed as marked using a manner of marking in accordance with some embodiments;

FIG. 10 shows illustrative display screen of the video of the program at a later time with the object displayed as marked using a different second manner of marking and with additional information being displayed in accordance with some embodiments;

FIG. 11 is a flow chart of a process for displaying a user selected object as marked based on the object's context in a program in accordance with some embodiments; and

FIG. 12 is a flow chart of a process for updating the location where and manner in which a user selected object is displayed as marked in accordance with some embodiments.

### DETAILED DESCRIPTION OF THE DRAWINGS

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

Some types of content may include a video signal. A video signal may include all information involved in generating a video for display, but accompanying metadata that is not used to display the video might not be considered part of the video signal. An on-demand program may therefore include a video signal (e.g., data that conveys the actual images to be generated for display), but not all data received as part of the on-demand program might be considered part of the video signal (e.g., synchronous metadata that describes individual scenes in the program may not be considered part of the video signal). For example, metadata defining the aspect ratio of the video, an appropriate brightness, or other features of a video to be displayed may be considered part of the video signal, while other metadata, such as the media guidance data and synchronous metadata described below, might not be considered part of the video signal.

Additionally, while a video signal may be described as a series of images, the video signal need not be encoded or processed in this manner. For example, even though a series of images is eventually displayed, all processing of the video signal leading up to the display may be performed on a compressed version of the video signal that has either its time and/or dimensional information converted into the frequency domain. However, such a compressed video signal may still be described as consisting of a series of images. Similarly, while processing or analyzing the compressed video signal may not involve processing or analyzing the images that may be eventually displayed to the user, such processing or analysis may still be considered image processing or analysis.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a website), or as stand-alone applications or clients on user equipment devices. Various devices and platforms that may implement media guidance applications are described in more detail below.

One of the functions of the media guidance application is to provide media guidance data to users. As referred to herein, the phrase, “media guidance data” or “guidance data” should be understood to mean any data related to content, such as media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

The media guidance data may also include synchronous metadata. Synchronous metadata may include fields indicating objects visible in a particular scene of a program, the location of these visible objects in a video of the scene, information describing one or more events occurring in the scene, and/or information describing the relationship of one or more objects (visible or otherwise) to the one or more events occurring in the scene. Synchronous metadata may also include information indicating which scene it is associated with and may be received by a user equipment device either before or during receipt of a related media asset. Alternatively or in combination, the synchronous metadata may be received by a user equipment device at the same time as the media asset, with the timing of its receipt indicating which scene each item of synchronous metadata relates to. Additionally, the synchronous metadata may be received automatically with or before the media asset, may be stored at a remote server and searched for by the user equipment device, may be received only in response to a request from the user equipment device, or any combination thereof. In one example, closed captioning may be considered a type of synchronous metadata.

An object in a program can include any physical item, individual, and/or region. Objects may include individual characters in a program, participants in a sporting event (e.g., runners in a race, players in a basketball game, and/or cars in a race), participants in any other type of event (e.g., nominees at an awards gala), regions of an event venue (e.g., the end-zone of a football field, the offside region during a soccer match, and/or the stage at an awards gala), and/or pieces of equipment (e.g., a ball at a tennis match, a discus at a discuss throwing competition, and/or a bar at a high jump competition). Additionally, objects in a program need not be visible at all times. For example, a character in a program that is present in a first scene, not present in a second scene, and then reappears in a third scene would still be considered an object throughout this time.

An event in a program may involve one or more objects. Any action taken by any one or more object may be considered an event. For example, an event might be the speaking of a line by an object (e.g., a character speaks any line of dialogue), the entering of a region by an object (e.g., a player runs into the end-zone), and/or a move or other action performed by an object (e.g., a player throws a ball). Alternatively or in addition, any act performed upon one or more objects may be considered an event. For example, an event may be an object being carried or otherwise moved into a particular region (e.g., the ball being carried into the end-zone), an object being moved in a particular manner (e.g., a ball being thrown), another object reaching the object (e.g., a player entering an end-zone), and/or any force or transformation being applied to the object (e.g., a clay disc being hit during a skeet shooting event). Additionally, an event may not be a singular action, but be made up of a series of actions, with each action in the series also constituting its own event.

The relationship between an object and the event may be described as an attribute of the object relative to the event. For example, if the object is a character and the event is a line being spoken, then an attribute of the object (i.e., the character) relative to the event (i.e., a line being spoken) may be “the current speaker” and/or “the speaker of the current line of dialogue.” As another example, if the object is a participant in a sporting event (e.g., a football player) and the event is a player scoring (e.g., the football player reaching the end-zone), then an attribute of the object (i.e., the participant) relative to the event (i.e., a point being scored) may be “the participant scoring a point” or “the participant scoring this point” (i.e., “the football player being the ball carrier who scored the touchdown”). As a third example, if the object is a participant in a sporting event (e.g., a player in a soccer match) and the event is a participant entering a particular region of a sporting venue (e.g., the offside area behind the second-to-last defensive player in a soccer match), then an attribute of the object (i.e., the participant) relative to the event (i.e., any participant entering a region) may be “the participant who entered the region” or “the participant who performed a particular action in the region” (i.e., “the soccer player who entered the offside area” or “the soccer player who made offensive contact with the ball in the offside region”). As a fourth example, if the object is a piece of equipment (e.g., a basketball) and the event is a piece of equipment being thrown (e.g., a basketball being passed), then the attribute of the object (i.e., the piece of equipment) relative to the event (i.e., the piece of equipment being thrown) may be “the piece of equipment being passed” (e.g., “the basketball is passed by the point guard”). As a fifth example, if the object is a region of a sporting venue (e.g., the end-zone on a football field) and the event is a participant entering the region (e.g., the ball carrier reaching the end-zone), then an attribute of the object (i.e., the end-zone) relative to the event (i.e., a player entering the end-zone) may be “a region entered by a particular participant” (e.g., the end-zone after the ball carrier enters it).

An object's attributes need not be consistent throughout a program. For example, an object's attributes relative to a particular event may change as the program progresses. Additionally or alternatively, prior events in a program may end and new ones may commence. As such, when an event ends, an object may no longer have a particular attribute associated with that event. Similarly, when a new event begins, an object may gain a new attribute relative to this new event. As one such example, an attribute of an object (e.g., a football player) relative to an event (e.g., the football being thrown) may initially be “covered by another player” (e.g., the football player may be covered by a player of the opposite team), followed by “open” (e.g., the football player may have escaped coverage), followed by “intended recipient” (e.g., the ball may be mid-air after the quarterback threw it towards the football player), followed by “ball carrier” (e.g., the football player may have caught the pass), and finally followed by “touchdown scorer” (e.g., the football player may have reached the end-zone with the football). As another example, an object (e.g., a character in a program) may be “the current speaker” in a first scene (e.g., a scene in which the character speaks a line of dialogue), not speaking or absent in a second scene, and therefore potentially “not the current speaker,” and the again “the current speaker” in a third scene.

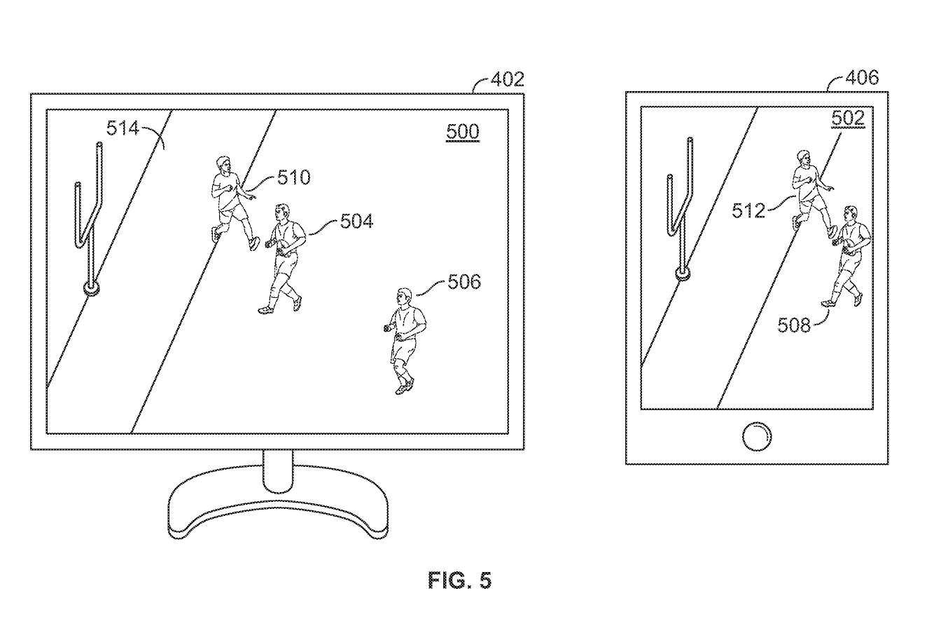

While the media guidance application is discussed as receiving and processing the media guidance information, including the synchronous metadata, any software or hardware, whether provided by media content source 416, discussed below, media guidance data source 418, discussed below, or a third party service, may access and process the media guidance information, including the synchronous metadata, in a similar manner. Accordingly, while FIGS. 5-12 are discussed below in relation to the media guidance application, a third party application or hardware may also perform or provide any of these processes or features.

Alternatively or additionally, the media guidance application may determine objects, attributes, and/or events by processing a media asset. For example, the media guidance application may use a content recognition module or algorithm to generate data describing the context, content, and/or any other data necessary for determining objects, attributes, and/or events in a media asset. For example, the content recognition module may use object recognition techniques such as edge detection, pattern recognition, including, but not limited to, self-learning systems (e.g., neural networks), optical character recognition, on-line character recognition (including but not limited to, dynamic character recognition, real-time character recognition, intelligent character recognition), and/or any other suitable technique or method to determine objects, attributes, and/or events in the media asset. For example, the media guidance application may receive data in the form of a video signal. The video signal may include a series of frames. For each frame of the video signal, the media guidance application may use a content recognition module or algorithm to determine the objects (e.g., people, places, things, etc.) in each of the frames or series of frames, which may be used to determine objects, attributes, and/or events in the media asset. For example, based on the detection of a multitude of flashing, bright lights in consecutive frames, the media guidance application may then determine that a particular event (e.g., an explosion) has occurred in the media asset.

In some embodiments, the content recognition module or algorithm may also include speech recognition techniques, including, but not limited to, Hidden Markov Models, dynamic time warping, and/or neural networks (as described above) to translate spoken words into text and/or processing audio data. The content recognition module may also combine multiple techniques to determine objects, attributes, and/or events in the media asset.

In addition, the media guidance application may use multiple types of optical character recognition and/or fuzzy logic, for example, when processing keyword(s) retrieved from data (e.g., textual data, translated audio data, user inputs, etc.) describing the media asset (or when cross-referencing various types of data in databases). For example, if the particular data received is textual data, using fuzzy logic, the media guidance application (e.g., via a content recognition module or algorithm incorporated into, or accessible by, the media guidance application) may determine two fields and/or values to be identical even though the substance of the data or value (e.g., two different spellings) is not identical. In some embodiments, the media guidance application may analyze particular received data of a data structure or media asset frame for particular values or text using optical character recognition methods described above in order to determine a characteristic of a media asset. For example, the media guidance application may process subtitles of the media asset to identify particular objects (e.g., characters) that appear in the media asset.

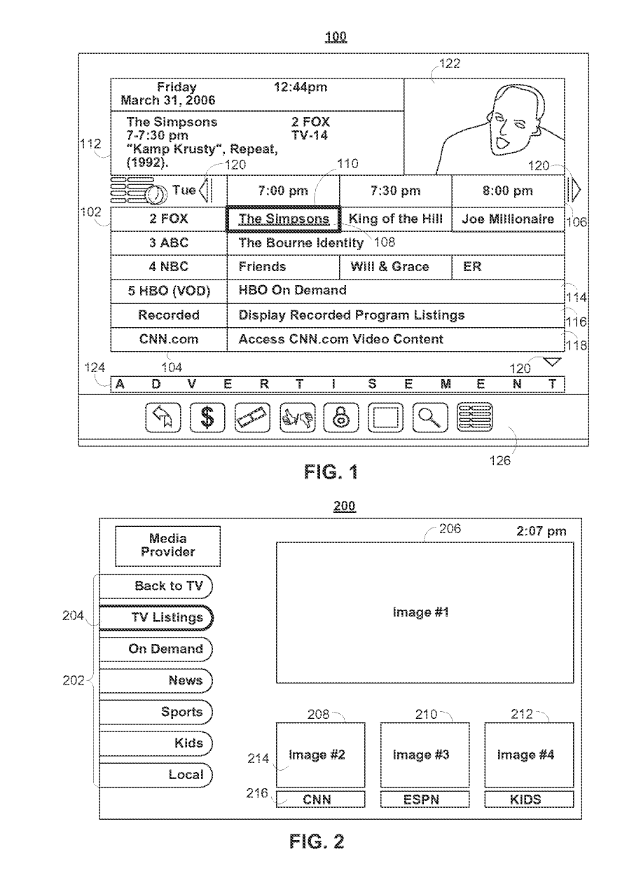

FIGS. 1-2 show illustrative display screens that may be used to provide media guidance data. For example, the displays shown in FIGS. 1-2 may appear on multiple screens as discussed in FIGS. 5-12. The display screens shown in FIGS. 1-2 may be implemented on any suitable user equipment device or platform. While the displays of FIGS. 1-2 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

FIG. 1 shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content that is accessible to a user equipment device at any time and that is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or webcast, or content available on-demand as streaming content or downloadable content through an Internet website or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different from display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. As referred to herein, triggering an interactive feature means executing a function. For example, triggering a function associated with advertisement 124 may involve executing any of the functions discussed above in response to a user selection of advertisement 124. Advertisement 124 may be targeted based on a user profile/preferences, monitored user activity, the type of display provided, or on other suitable targeted advertisement bases. The function executed in response to a user selection of advertisement 124 may also be impacted by the user profile/preferences. For example, the user profile/preferences may include login information for one or more social networking services. In this example, in response to a user selection of advertisement 124, the login information is retrieved and a function is performed in connection with the social networking service identified in the user profile/preferences. Such a function may include updating an online profile to indicate a preference for a program or product associated with advertisement 124, transmitting a message to other members of the user's social network, generating an online post related to advertisement 124 and/or otherwise impacting the user's online presence.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display.

Advertisements may also include text, images, rotating images, video clips, or other types of content described above. While advertisement 124 is illustrated as a single element within display 100, an advertisement may include multiple distinct regions or elements. For example, a first area of an advertisement may include an image, while other elements of an advertisement may include selectable options that are each associated with a different interactive feature. In this example, receiving a user selection of the image does not trigger any interactive feature, while a user selection of one of the selectable options may trigger a different interactive feature associated with each selectable option.

Advertisements may be stored in a user equipment device having a guidance application, in a database connected to the user equipment, in a remote location (including streaming media servers), or on other storage means, or a combination of these locations.

Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. One or more of these interactive features may also be associated with advertisement 124. For example, if advertisement 124 is for a program, any one of these interactive features may be triggered in response to a user selection of advertisement 124. As another example, advertisement 124 may include multiple selectable options that each triggers one of these interactive features. Options available from a main menu display may include search options, VOD options, parental control options, Internet options, cloud-based options, device synchronization options, second screen device options, options to access various types of media guidance data displays, options to subscribe to a premium service, options to edit a user profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other websites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200, the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

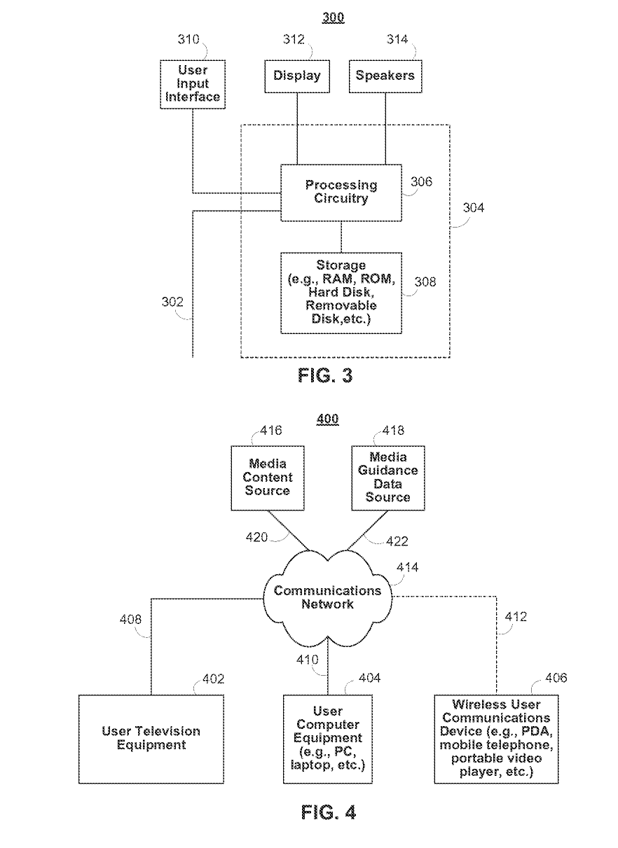

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter, “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 304 and storage 308. Control circuitry 304 may be used to send and receive commands, requests, and other suitable data using I/O path 302. I/O path 302 may connect control circuitry 304 (and specifically processing circuitry 304) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 304. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). Processing circuitry 304 may also include one or more multi-threaded processors, with the multiple threads interacting in a similar manner as the multiple separate processors. Accordingly, processing discussed as being performed by multiple separate processors below may also be performed by different threads of a single processor. In some implementations involving multiple processors and/or multi-threaded processors, the multiple processors and/or threads of a single processor may exchange processing results and other data using tightly coupled memory (e.g., a part of storage 308). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above-mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and guidance application data, described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content, including any video signal that is part of the content. The tuning and encoding circuitry may also be used to receive guidance data. The circuitry described herein, including, for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. Input interface 310 may generate as output one or more coordinates corresponding to a user selection. For example, if a user selects a single point in display 312, a single set of coordinates may be outputted by input interface 310. If input interface 310 is, e.g., a touch screen or touch pad, and user drags a finger over the surface of display 312, input interface 310 may output a set of coordinates corresponding to the motion of the finger on the surface of display 312. Phrases such as “drawing a border around” or “circling,” as used herein, do not require user to input a complete border around an object or to input a perfect circle. Instead, such phrases may be used to refer to any user input that selects an object by drawing an approximate border or circle around it. For example, any input that draws more than a semicircle around an object may be considered as drawing a border or circle around the object.

Display 312 may be one or more of a monitor, a television, a liquid crystal display (LCD) for a mobile device, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a website accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, and wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

A second screen device may be used to receive user input that affects the display of information on another user equipment device. For example, user input received at wireless user communications device 406 may be used to determine what information to display at user television equipment 402. Accordingly, a user selection of a program listing on wireless user communications device 406 may cause a detailed description or the program itself associated with the program listing to be displayed on user television equipment 402. This may be accomplished by causing each of user television equipment 402 and wireless user communications device 406 to display the same information or programming, and for each to mirror any user input received at the other one. For example, a user may independently select the same information or programming on each of the two user equipment devices, and the two user equipment devices may automatically determine that user input received at the first equipment device ought to affect the information or programming displayed at both. As another example, one or both of the two user equipment devices may receive user input requesting the launch of an application or the entering of a mode wherein any input received at the first user equipment device impacts the programming or information displayed on the second device. Alternatively or in addition, one of the two user equipment devices (e.g., wireless user communications device 406) may display a set of selectable options that control the information or programming displayed on the other one (e.g., user television equipment 402). For example, a first user equipment device may receive user input entering a mode or application wherein the first user equipment device acts as a second screen device for receiving input for another device. In this scenario, the first user equipment device may act as, e.g., a remote control for the second user input device. A combination of these scenarios is also possible. For example, the same content may be displayed on a first and a second user equipment device, but only one of the first and second user equipment devices may be configured to receive input affecting the other user equipment device by displaying a set of selectable options alongside the content.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the website www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

A second screen device may be automatically identified based on the configuration of network 414. For example, if user television equipment 402 and wireless user communications device 406 are capable of communicating over a local network, wireless user communications device 406 may automatically determine that it may act as a second screen device for television equipment 402, or vice versa. Alternatively or in addition, the user profile information may indicate that either one or both of television equipment 402 and user communications device 406 may act as a second screen device for the other based on user input. For example, a user may enter a network address corresponding to either of television equipment 402 and user communications device 406 that is saved in the user profile information for identifying a second screen device when it accesses communications network 414.

The user equipment devices may be coupled to communications network 414. Namely, user television equipment 402, user computer equipment 404, and wireless user communications device 406 are coupled to communications network 414 via communications paths 408, 410, and 412, respectively. Each of television equipment 402, user computer equipment 404, and wireless user communications device 406 may have its own address (e.g., IP address) on communications network 414. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance application data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

While synchronous metadata is described above as part of the media guidance data, this need not be the case. The synchronous metadata may, alternatively or in addition, be received together with or separately from content from media content source 416. In addition or alternatively, some or all of the synchronous metadata may be received from a third party server (not pictured) associated with a third party service that is independent from both media content source 416 and media guidance data source 418. Any of the synchronous metadata discussed below may be received from any one of the three sources—media guidance source 416, media guidance data source 418, and the third party server—automatically or in response to a request transmitted by user equipment device 300.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

FIG. 5 illustrates one manner in which a first user equipment device may act as a second screen device for a second user equipment device. In this example, wireless user communications device 406 may act as a second screen device for user television equipment 402. While this example is discussed in terms of wireless user communications device 406 and user television equipment 402, a person of ordinary skill would recognize that any user equipment device may act as a second screen device for any other user equipment device in this manner. User television equipment 402 causes screen 500 to be displayed. Within screen 500, object 514 (i.e., the end-zone of a football field), object 510 (i.e., a first participant in a sporting event—a first football player), object 504 (i.e., a second participant in a sporting event—a second football player), and object 506 (i.e., a third participant in a sporting event—a third football player) are presented. Similarly, wireless user communications device 406 causes screen 502 to be displayed. Within screen 502, object 516 (i.e., the end-zone of a football field), object 512 (i.e., a first participant in a sporting event—a first football player), and object 508 (i.e., a second participant in a sporting event—a second football player) are presented. Both user television equipment 402 and wireless user communications device 406 simultaneously present the same program, in this case a football game, and object 514 corresponds to object 516, object 510 corresponds to object 512, and object 504 corresponds to object 508.

In one embodiment, wireless user communications device 406 may act as a second screen device for user television equipment 402. Wireless user communications device 406 may have a touch screen and may receive coordinates corresponding to a figure traced by a user on screen 502. Such a figure may circle, draw a border, or otherwise select any one of objects 516, 512, and 508. Such a user selection may, besides corresponding to a user selection of an area of the video presented on screen 502, also indicate a user selection of one of corresponding objects 514, 510, and 504, respectively, on screen 500. The processing involved in determining which object in screen 502 corresponds to input received at wireless user communications device 406 may be performed by control circuitry of wireless user communications device 406, user television equipment 402, media guidance data source 418, any other computer having control circuitry that is connected to communications network 414, regardless whether such a computer is connected to one or both of wireless user communications device 406 and user television equipment 402 over a local network or a wide area network, or any combination thereof. For the sake of simplicity, the processing involved in FIGS. 5-12 will be discussed as performed by control circuitry 304, but a person of ordinary skill would understand that such control circuitry may be present on any one of wireless user communications device 406, user television equipment 402, media guidance data source 418, any computer having control circuitry that is connected to communications network 414, regardless whether such a computer is connected to one or both of wireless user communications device 406 and user television equipment 402 over a local network or a wide area network, or combination thereof. Moreover, while the processing will be occasionally discussed as performed by the media guidance application, this need not be the case. Accordingly, the processing may be performed by the media guidance application or any other application implemented on any of the device or combination thereof noted above. Additionally, a person of ordinary skill would understand that any discussion of the media guidance application or another application performing any processing or other steps may refer to instructions corresponding to parts of the media guidance application or another application being loaded into main memory and executed by control circuitry 304.

Control circuitry 304 may automatically determine that the wireless user communications device 406 is to act as a second screen device for user television equipment 402. For example, video corresponding to the same program may be presented on display 312 of each of wireless user communications device 406 and user television equipment 402 responsive to an independent user selection of the same program at each of wireless user communications device 406 and user television equipment 402. Control circuitry 304 may determine that video corresponding to the same program is being presented on both devices without receiving any user input further to the independent selection of the same program and any subsequent trick-play input (e.g., pause, play, fast forward, skip forward, rewind, skip backwards). Control circuitry 304 may cause an indication that one or both of user television equipment 402 and wireless user communications device 406 is acting as a second screen device for the other user equipment device to be displayed on either one or both of the user equipment devices. Upon making this determination, control circuitry 304 may cause any effect of input received at one of the two devices (e.g., wireless user communications device 406) to also apply to the other device (e.g., user television equipment 402). Alternatively or in addition, control circuitry 304 may cause any effect of input received at one of the two devices (e.g., wireless user communications device 406) to only apply to the other device (e.g., user television equipment 402).

In addition or alternatively, wireless user equipment device 406 may act as a second screen device for user television equipment 402 and/or vice versa responsive to a manual user request. For example, a video of a program may be presented on user television equipment device 402. In this example, control circuitry 304 may receive a user request for the wireless user communications device 406 to act as a second screen device and, responsive to this request, cause screen 502 to be presented on wireless user communications device 406.

Additionally or alternatively, any user input or selection discussed as being received by a second screen device may also be received directly by the primary device. For example, any user selection or input discussed as being received by wireless user communications device 406 may also be received directly by user television equipment 402. Accordingly, while most discussion herein focuses on two user equipment devices, one of which acts as a second screen device for the other, the same discussion is equally applicable to a single user equipment device that both presents media content and receives user input.

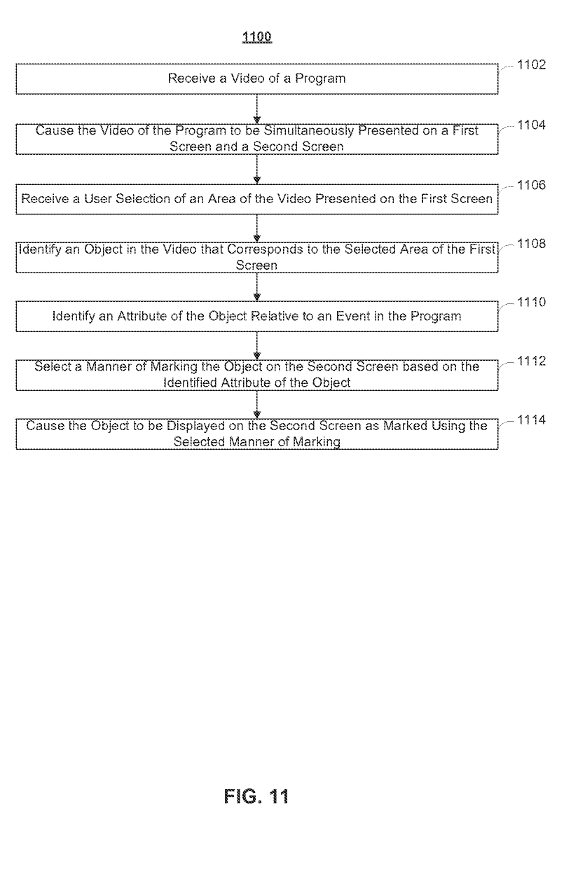

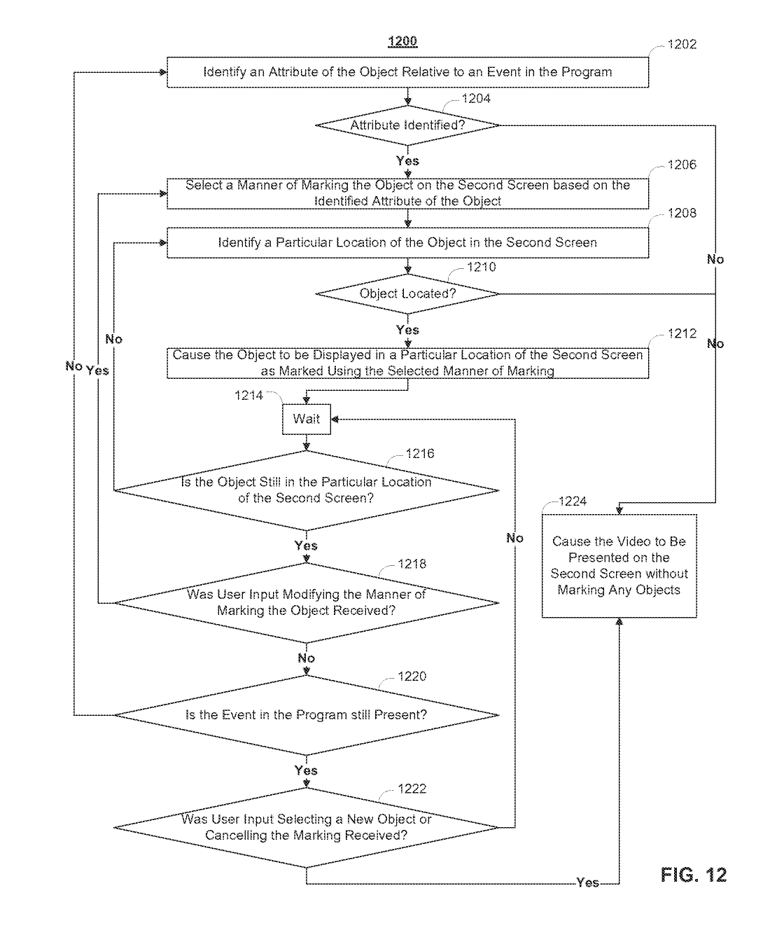

Wireless user communications device 406 and user television equipment 402 need not have the same resolution and other hardware or software configuration to display the same program. Accordingly, object 506 may be visible in user television equipment 402, while no corresponding object is visible in wireless user communication device 406. However, based on processing discussed below in reference to FIGS. 11 and 12, control circuitry 304 may still determine that a user selection of any one or more of objects 516, 512, and 508 at wireless user communications device 406 corresponds to objects 514, 510, 504 presented in screen 500 of user television equipment 402, respectively.

A user selection of any one or more of objects 516, 512, and 508 may be received as a user input by receiving a user selection of an area of the video presented in screen 502. Such a user selection may be received as one or more user inputs. For example, a single coordinate pair corresponding to a user selected location within a particular object presented in screen 502. Alternatively or in addition, a user selection of any one or more of objects 516, 512, and 508 may be received by receiving a set of coordinate pairs corresponding to a border drawn around that particular object in screen 502. This may entail a full circle being drawn around the particular object, an arc or any other shape that partially encircles an object being drawn around the object, a non-closed circle (e.g., a spiral) that goes fully around the particular object but does not close onto itself being drawn, and/or a cross being drawn that may have as its intersection a location with the object and/or whose start and end points may indicate the extent of the area. The input need not fully encompass the selected object (i.e., parts of the object may be left outside of a border drawn by the user) for control circuitry 304 to identify which objected presented on screen 520 and/or corresponding object on screen 500 is selected by the user. Input corresponding to a user selected line may be referred to as telestator-type user input. Such telestator-type input may correspond to an area of screen 500 and/or screen 502 in which a user selected object is presented, whereas input received via a single coordinate pair may correspond to only a single point. However, even an input corresponding to a single point may correspond to a user selection of an area. For example, control circuitry may process the received video signal and/or analyze the received synchronous metadata to identify an area corresponding to the single point.

Since a video of the same program is being presented on each of screen 500 and screen 502, identifying an object and its attribute relative to an event in the program may be discussed as being performed in relation to screen 500 and/or screen 502. For example, control circuitry 304 may identify a user selected object in screen 502 based on the area and/or point selected in screen 502, and then determine the attribute of the object in screen 502 and/or the attribute of the corresponding object in screen 500. However, as another example, control circuitry 304 may first calculate a corresponding user selected area and/or point in screen 500 (e.g., by converting coordinates received in relation to screen 502 to equivalent coordinates in screen 500 based on the resolutions of the two screens) and then identify the corresponding object presented in screen 500.

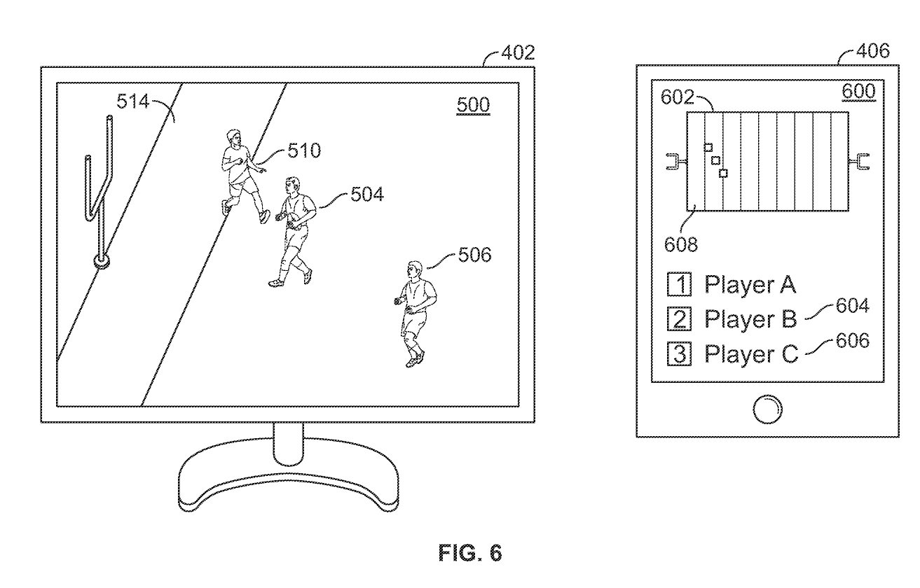

FIG. 6 illustrates an alternative manner in which a first user equipment device may act as a second screen device for a second user equipment device. Similar to FIG. 5, FIG. 6 also includes user television equipment 402 presenting screen 500 that includes objects 514, 510, 504, and 506. However, here wireless user equipment device 406 presents display 600. Display 600 includes venue presentation 602, including region 608, and a player list that includes player 604 and player 606.

Control circuitry 304 may determine that wireless user communications device 406 is to act as a second screen device for user television equipment 402 using the automatic and/or manual process discussed above. However, upon making this determination, control circuitry 304 may cause wireless user communications device 406 to display screen 600 with supplemental information and options instead of a video corresponding to the program presented in screen 500. For example, screen 600 may include venue presentation 602 which indicates a location of each participant in a sporting event whose video is being presented in screen 500. Venue presentation 602 may include end-zone 608 which corresponds to object 514 in screen 500. Additionally, screen 600 may include a list of participants in the sporting event, including player 604 corresponding to 504 and player 606 corresponding to object 506.

Control circuitry 304 may receive user input corresponding to any of the options presented in screen 600. However, a person of ordinary skill would differentiate between a user selection of an object in a video of a program (e.g., a user selection of an object presented in screen 502) and a user selection of an option (e.g., a user selection of an option presented in screen 600). Unlike user input received of a point or area in screen 502, a user selection of an object in screen 600 may cause control circuitry to receive information identifying the selected option instead of coordinates corresponding to a point or area in the screen. Additionally or alternatively, the locations of the options presented in screen 600 may be locally determined and/or generated by wireless user communications device 600, whereas the coordinates corresponding to each of the objects presented in screen 502 may be dictated by video and/or synchronous metadata received from media content source 416 and/or media guidance data source 418.

The information and options presented in screen 600 may be generated specifically to the program whose video is presented in screen 500. For example, the media guidance data received from the media guidance data source 418 for the program may include information indicating what information and options to present in screen 600. The presented information and options may be received as part of the media guidance data and/or may be subsequently retrieved based on the information received in the media guidance data. For example, information identifying a particular sporting event may be used to retrieve information from a third party server (e.g., the website of one of the teams participating in the sporting event and/or a play-by-play live data feed for the particular sporting event) regarding players participating in the event, and this information may subsequently be used by control circuitry 304 to generate options corresponding to player 604 and 606. Additionally or alternatively, the information and options presented in screen 600 may be specific to a type of program whose video is presented in screen 500. For example, the media guidance data may indicate that the program is a football match. Based on this information along with the current time, control circuitry 304 may identify the particular football match and use this information to retrieve the information and options presented in screen 600.

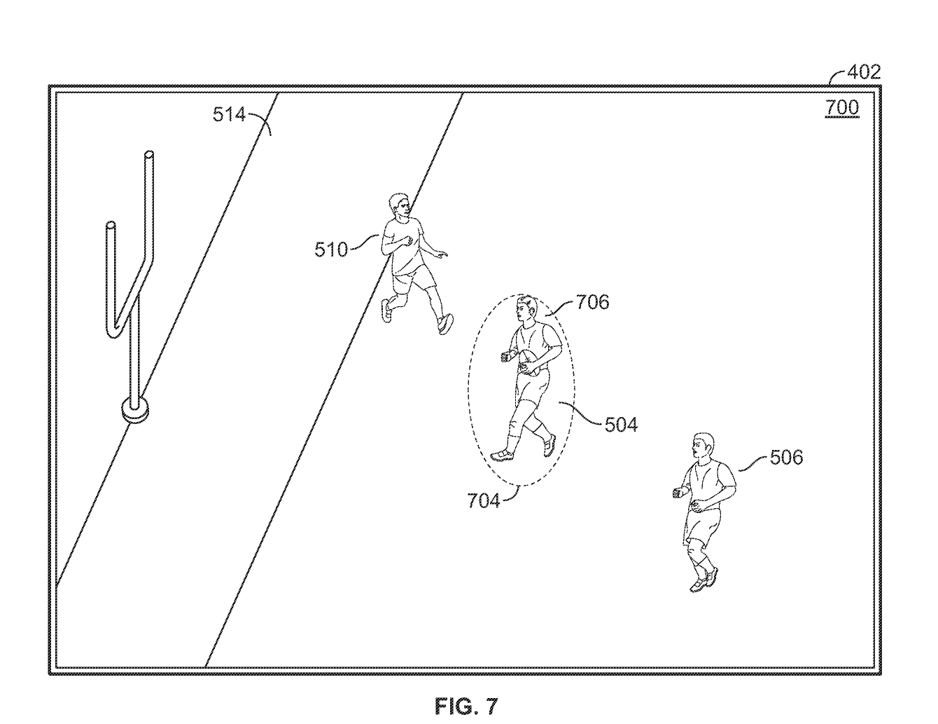

FIG. 7 shows illustrative screen 700 displayed on user television equipment 402. Screen 700 may present a video of the same program presented on screen 500, together with objects 514, 510, 504, and 506. Screen 700 may be displayed after control circuitry 304 received a user selection of object 504.

The user selection of object 504 may include a user input corresponding to border 704 that selects area 706. Control circuitry 304 may cause border 704 to be displayed in order to mark object 504. Control circuitry 304 may select a particular manner of displaying border 704. A manner of displaying border 704 may include any manner of visually or otherwise indicating where the border is located and/or that the object is marked. A manner of marking an object may include a type of marking, such as any one or more of highlighting (e.g., by coloring, bordering, and/or changing brightness of) an object, displaying text associated with the object, generating for display an arrow or other indication associated with the objected, presenting audio cues or voice overs describing the object, and/or causing a remote control to vibrate at a particular point in time (e.g., when it is directed towards the object), and/or a particular manner of how each one of these types of markings is presented to a user (e.g., one or more of colors, patterns, shapes, sounds, and/or rhythms involved). The content of displayed text (e.g., “this is player A” vs. “this is player B”) may not be considered part of the manner of marking an object, although the presence of any text (i.e., whether any text at all is being displayed) may be part of the manner of marking. For example, the particular manner of display may include determining to mark the object by causing border 704 to be displayed, as well as a particular color (e.g., green), a particular pattern (e.g., dotted) and/or a particular shape (e.g., a zig-zag line) used to display border 704. Additionally or alternatively, control circuitry 304 may mark object 504 by causing area 706 to be displayed using a particular manner that may include a particular color scheme. For example, control circuitry 304 may cause a color filter to be applied to area 706 to manipulate the color scheme presented therein, thereby marking its extent.

Moreover, while border 704 and area 706 are illustrated in screen 700 as directly corresponding to the received user input, this need not be the case. For example, the received user input may not have included all of area 704 or may have failed to fully close a circle corresponding to border 704. After control circuitry 304 identifies object 504 as selected based on the processing discussed below in reference to FIG. 11, the control circuitry may determine a new border 704 and/or area 706 based on the identification performed by control circuitry 304.

Control circuitry 304 may select the manner in which border 704 and/or area 706 are displayed based on an attribute of object 504 relative to an event in the program whose video is presented in screen 700. For example, control circuitry 304 may select a manner of displaying border 704 and/or area 706 based on control circuitry 304's determination that object 504 is the ball carrier relative to the event of an active play occurring in the sporting event.

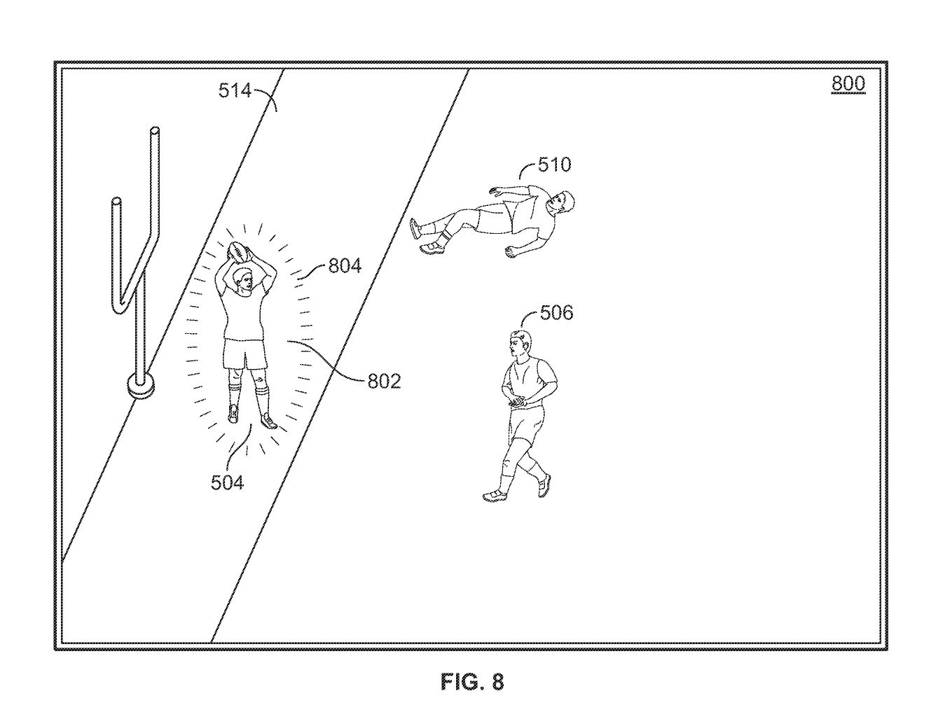

FIG. 8 shows illustrative screen 800 that includes objects 504, 514, 510 and 506. The video presented in screen 800 is a video of the same program also presented in screen 700 but at a later point in time. The position of object 504 has moved within screen 800 from its position within screen 700. Control circuitry may automatically determine that the location of object 504 has moved and automatically cause border 804 and/or area 802 to be displayed in a new location of object 504 within screen 800 instead of the location where border 704 and/or area 706 are presented in screen 700. This updating may occur without any user selection of a new point or area within screen 800.

Control circuitry 304 may have also determined at this later point in time that an attribute of object 504 is no longer “ball carrier” but is now “touchdown scorer” relative to the event of the currently active play and/or relative to a new event of a touchdown being scored. Based on this determination, control circuitry 304 may select a new manner (i.e., not the manner in which border 704 and/or area 706 are displayed) for marking object 504. Accordingly, border 804 and/or area 806 may be displayed in a different manner than border 704 and/or area 706. This may entail selecting a new type of marking (e.g., using border 804 alone instead of area 706 alone), border color, border shape, border pattern, area color scheme, any other manner of visually marking object 504, and/or a combination thereof.

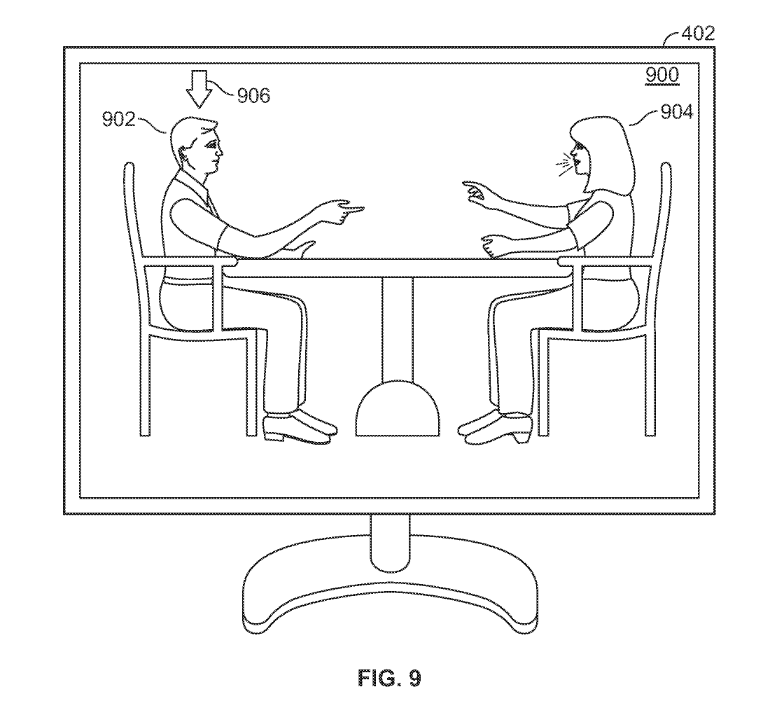

FIG. 9 shows illustrative screen 900 that presents a video of a program involving two characters, objects 902 and 904. Control circuitry 304 may cause indication 906 to be displayed responsive to identifying object 902 as having been selected by the user. Control circuitry 304 may determine that an attribute of object 902 relative to an event in the program is that object 902 is not the speaker of a line of dialogue currently being spoken, and control circuitry 304 may accordingly cause indication 906 to be displayed in a first manner.

Indication 906 may be at a location associated with object 902 and thereby indicate the location of object 902. In one example, indication 906 may be an arrow that points at object 902. As with border 704 and/or area 706, control circuitry 304 may select a manner of marking object 902 (e.g., a decision to display indication 906 instead of a border, a shape of indication 906, a color of indication 906, and/or a pattern of indication 906) based on an attribute of object 902 relative to an event in the program (e.g., based on the determination that object 902 is not the active speaker relative to a currently spoken line of dialogue).

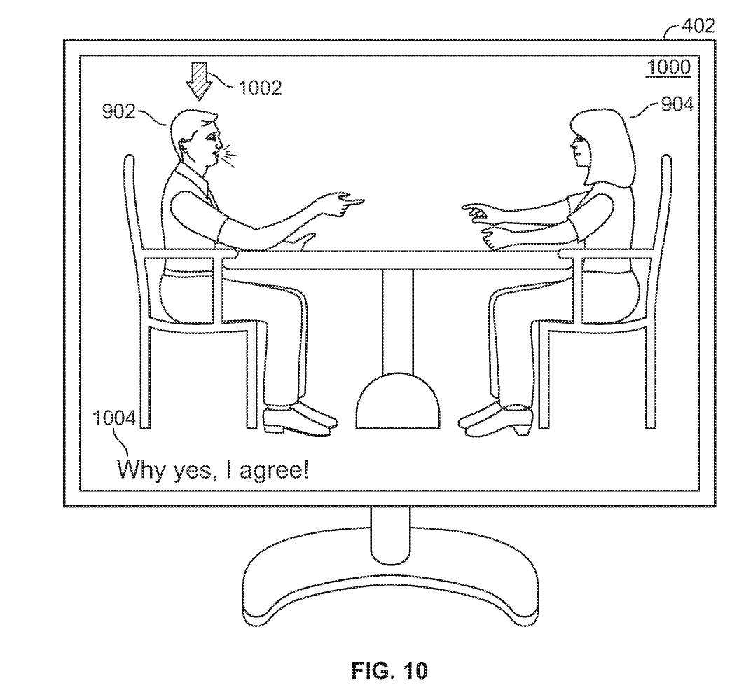

FIG. 10 shows illustrative screen 1000 that presents a video of the same program also presented in screen 900, but at a later point in time. Screen 1000 also includes objects 902 and 904. However, control circuitry 304 may have determined at this later point in time that an attribute of object 902 is now an “active speaker” relative to the line of dialogue currently being spoken. Accordingly, control circuitry 304 may cause indication 1002 to be displayed in a different manner (e.g., a different shape and/or color) than indication 906 in screen 900.

In addition to changing the manner in which the indication is displayed, control circuitry 304 may also cause additional information, such as dialogue transcript 1004, to be displayed. Control circuitry 304 may therefore select whether to display additional information and what additional information to display based on an attribute of a user selected object relative to an event in a program.

FIG. 11 shows flowchart 1100 illustrating a process by which control circuitry 304 marks a user selected object based on an attribute of the object relative to an event in a program. At step 1102, control circuitry 304 and/or control circuitry of one or more other user equipment device in communication with control circuitry 304 over communications network 414 receives a video corresponding to the program. At step 1104, each of a first screen and a second screen simultaneously presents the video. For example, each of user television equipment 402 and wireless user communications device 406 may cause a video of the same program to be displayed on its respective display screen, resulting in the presentation of screens such as screens 500 and 502. At step 1106, control circuitry 304 receives a user selection of an area of the video presented on the first screen. Control circuitry 304 may receive the user selection by receiving a set of coordinates corresponding to one or more lines inputted by the user. For example, control circuitry 304 may receive a set of coordinates corresponding to border 704 or coordinates of an equivalent border on wireless user communications device 406. Either one of these sets of coordinates may correspond to a user selection of area 706 and/or object 504 located therein.

At step 1108, control circuitry 304 may identify an object found in the area of the video corresponding to the user selected area of the first screen (e.g., screen 502 of wireless user communications device 406). Control circuitry 304 may process the video signal corresponding to the program and/or synchronous metadata associated with the program. For example, control circuitry 304 may compare the selected area against a number of patterns and/or images stored as part of the media guidance data received by the user equipment device. Control circuitry 304 may compare the selected area against a set of images corresponding to characters and/or participants (e.g., football players) associated with the program. These images may be received as part of the media guidance data. Alternatively or in addition, an image of the selected area may be transmitted to media guidance data source 418 for a similar comparison. Alternatively or in addition, media guidance data corresponding to the program may be used to search a third party server. For example, the media guidance data may be used to contact a third party server of a third party service with biographies and images of actors and actresses found in a number of programs and/or players that are members of a number of professional sports teams. The third party service may return images that control circuitry 304 then compares to the selected area, and/or the selected area may be transmitted to the third party server over communications network 414 so that the third party service may perform the comparison. For example, control circuitry 304 may compare the selected area against images found as part of player rosters on one or more websites of one or more sports teams participating in a sporting event to determine whether an object potentially presented in the user selected area is a participant in the sporting event. In another example, control circuitry 304 may compare the selected area against an Internet database of movie information that includes images of actors (either all actors and actresses, actors and actresses active during the time period the presented program was filmed and/or actors and actresses who starred in the presented program).

Control circuitry may also analyze the video signal corresponding to the program to identify any objects found in the user selected area by performing optical character recognition (OCR) upon the selected area or any other content recognition technique discussed above. Any text located within the selected area may correspond to a player jersey number and/or the name of the player written on his or her jersey. This information may itself sufficiently describe the user selected object, and/or control circuitry 304 may use this information to search the media guidance data and/or a database of the third party server for additional information.

Alternatively or in addition, control circuitry may process synchronous metadata that identifies objects found in each scene of a program to identify an object in the user selected area. For example, the synchronous metadata may include one or more coordinates corresponding to objects found in each scene. Control circuitry 304 may determine which coordinates found in the synchronous metadata to use for identifying an object by using the most recently received synchronous metadata (if the synchronous metadata indicates what scene it is associated with based on the timing of its receipt) or by retrieving the synchronous metadata associated with a timestamp corresponding to the currently presented scene of the program (if the synchronous metadata indicates what scene it is associated with based on time stamps corresponds to scenes). These coordinates may be used to identify which objects are found within the user selected area and/or are closest to being in the user selected area. Control circuitry may use the coordinates received as part of the synchronous metadata as the location of border 704 and/or area 706 in lieu of the user inputted coordinates. Control circuitry 304 may in this manner correctly cause a border to be displayed around the object even if the user inputted coordinates failed to encircle the entire object.

Control circuitry 304 may also process both the received video signal and the synchronous metadata to identify a user selected object. For example, control circuitry 304 may process the video signal to determine whether the selected area includes a human character that is currently speaking (e.g., by analyzing the video signal to determine whether a human mouth is moving in the selected area). If control circuitry 304 determines that such a human character is presented in the selected area, control circuitry 304 may retrieve any information identifying the current speaker that is received as part of closed captioning and conclude that the current speaker is the user selected object.

Control circuitry 304 may similarly utilize a single pair of coordinates to identify an object closest to these coordinates. For example, control circuitry 304 may use an area of a predefined size or an area corresponding to lower variations in color pattern (which indicates that the area is likely to be part of a single object) to process the video signal in the manner discussed above. In addition or alternatively, control circuitry 304 may use the synchronous metadata to identify the object whose coordinates are the closest to the user selected coordinate pair. If control circuitry 304 receives a user selection of one of the options presented in screen 600, control circuitry 304 may be able to identify the corresponding object by retrieving information received together with the information used to generate screen 600 and without having to process synchronous metadata or the video signal.

At step 1110, control circuitry may identify an attribute of the identified object relative to an event in the program. This attribute may be indicated by the same synchronous metadata used to identify the object. Alternatively or in addition, control circuitry may use information identifying the object to retrieve the attribute of the object. For example, after identifying the selected object as a particular participant in a sporting event, control circuitry 304 may use the identify of the participant to retrieve information on current events in the sporting event from a live data feed regarding the sporting event, and use this information to determine attributes of the selected object relative to each of these current events. The live data feed may, for example, include information identifying the current ball carrier and the position of the ball in each play of a football match, and control circuitry 304 may use this information to identify an attribute of the object relative to these events.

As another example, control circuitry 304 may analyze the video signal to determine any actions performed by the user selected object. For example, if the object is a human character in a program, control circuitry 304 may analyze the face and specifically any motion of the mouth of the character to determine if the object is the active speaker of a current line of dialogue. The dialogue itself may be received as closed captioning or separately identifying using speech recognition performed by control circuitry 304 on the audio component of the program. Additionally or alternatively, control circuitry 304 may use any information identifying a current speaker that is received as part of the synchronous metadata (e.g., closed captioning) to determine whether the user selected object is the current speaker.

At step 1112, control circuitry 304 may select a manner of marking the user selected object on a second screen (e.g., user television equipment 402) based on the identified attribute of the object. For example, control circuitry 304 may retrieve a look-up table specific to the program (e.g., a look-up table received with the media guidance information regarding the particular program), specific to the type of program (e.g., control circuitry may use a first look-up table for sporting events and a second look-up table for a movie), and/or generic to all programming. The look-up table may indicate a display manner for use in marking the selected object on the second screen (e.g., screen 500 of user television equipment 402). The manner of display may include whether to mark the object by displaying a border (e.g., border 704), by shading an area of the second screen (e.g., area 706), and/or by causing an indication to be displayed (e.g., indication 1002). The look-up table may also or alternatively indicate a particular border color, indication color, border pattern, border shape, indication shape, indication pattern, and/or area color scheme to be used to signify the identified attribute.

Additionally or alternatively, storage 308 may contain information describing a number of different manners in which an object may be marked. These manners may be stored directly in the look-up tables described above or the look-up tables may contain pointers to locations within storage 308 where the manners of marking an object are stored. The information present in storage 308 may indicate what type of marking to use (e.g., by displaying text, providing an audio cue, displaying an indication, displaying a border and/or coloring the relevant area) as well as details regarding how the marking is to be presented to the user (e.g., one or more of color, pattern, shape, sound, and/or rhythm).

In addition or alternatively, the same look-up table may indicate what and whether to display additional information, such as dialogue transcript 1004. The content of the additional information may be found directly in the look-up table, received together with the synchronous metadata, received as element of the synchronous metadata (e.g., closed captioning), and/or retrieved from a remote server such as media guidance data source 418 and/or a third party server (e.g., retrieving player statistics to be displayed if the user selected object is a player in a football match). For example, control circuitry 304 may display closed captioning only for lines of dialogue spoken by a user selected character. As another example, control circuitry 304 may automatically display names, positions and/or statistics for any participants in a sporting event that enter a user selected region of a sporting venue.

Control circuitry 304 may also take into consideration user preferences when selected the manner of marking a user selected object. Such preferences may be received as user input at the first user equipment device (e.g., wireless user communications device 406), may be received as user input at the second user equipment device (e.g., user television equipment device 402), may be received as user input at any other user equipment device in communication with control circuitry 304, may be retrieved from the user profile information, and/or any combination thereof. For example, the user preference may reflect a user request to only mark objects using an indication as opposed to a border or to avoid and/or use certain colors, shapes, and/or patterns. Additionally or alternatively, the manner in which a user selection of the identified object is received may also affect the manner in which the object is marked. For example, if the user selection of the area is received via a touch-screen, the amount of force applied by the user to the screen when making the selection may be used in selecting the manner of marking the object, quantitatively (e.g., the more force the user applied, the stronger hues of colors are used to display border 704 and/or the less transparent an overlay marking area 706 is) and/or qualitatively (e.g., area 706 is only shaded if the user applied above a certain threshold of force; otherwise, only border 704 is displayed).

At step 1114, control circuitry 304 causes the object to be displayed as marked on the second screen (e.g., screen 500 of user television equipment 402) using the selected manner of marking. This may involve one or more of causing border 704 to be displayed as an overlay, the color scheme of area 706 to be modified (e.g., by displaying a transparent overlay or by modifying the color scheme of the area by adding an additional hue to those pixels), and/or indication 1002 to be displayed.

FIG. 12 shows flowchart 1200 illustrating a process for updating the location where and manner in which a user selected object is displayed as marked.

At step 1202, control circuitry may identify an attribute of the object relative to an event in the program. This step may include any of the processing discussed above in reference to step 1110 of FIG. 11 discussed above. At step 1204, control circuitry 304 may determine whether it was successful in identifying an attribute of the object. For example, if one, more, or all of the techniques discussed above in reference to 1110 were unsuccessful, control circuitry 304 may determine that it was unable to identify an attribute of the object. If control circuitry 304 determines that it was unable to identify an attribute of the object relative to an event in the program, control circuitry 304 may proceed to step 1224 and cause the video of the program to be presented on the second screen (e.g., a screen of user television equipment 402) without marking any objects. Additionally, control circuitry 304 may cause an indication to be presented on either the first screen (e.g., a screen of wireless user communications device 406) and/or the second screen (e.g., a screen of user television equipment 402) indicating that no object is marked and/or prompting the user to again select a point or area for which control circuitry 304 will again attempt to identify an object and its attribute.

If control circuitry 304 determines at step 1204 that it identified an attribute of the object, control circuitry 304 may select at step 1206 a manner of marking the object on the second screen based on the identified attribute of the object. This step may include any of the processing discussed above in reference to step 1112 of FIG. 11 discussed above.

At step 1208, control circuitry 304 may identify a particular location of the user selected object in the second screen (e.g., the location of object 504 in screen 700). This location may be a single point or an area. For example, control circuitry 304 may identify a location that corresponds to the user selected area or to an area indicates by coordinates retrieved from the synchronous metadata. Additionally, control circuitry 304 may analyze the video signal to modify this location for the object. For example, control circuitry 304 may identify the location of the object as the user selection location of the object plus any area in its immediate vicinity that exhibits the same color spectrum, which indicates that the additional area is probably part of the same object. Additionally or alternatively, the particular location may correspond to a single point either selected by the user or indicated by the synchronous metadata. Control circuitry 304 may then separately process the received video signal to identify the extent of the selected object to display, e.g., border 704 and/or area 706. While step 1208 is discussed as being performed after step 1202 and 1204, this need not be the case. For example, step 1208 may be performed before step 1202.

At step 1210, control circuitry 304 may determine if it identified a particular location for the object. If control circuitry 304 determines that no location was identified for the object, control circuitry 304 may proceed to step 1224. Otherwise, control circuitry 304 may proceed to step 1212. At step 1212, control circuitry 304 may cause the selected object to be displayed as marked at the particular location in the second screen (e.g., screen 700) using the selected manner of marking. This step may include any of the processing discussed above in reference to step 1114 of FIG. 11 discussed above.

At step 1214, control circuitry 304 waits. The wait may be for a predetermined amount of time (e.g., 1 second), based on resource availability (e.g., control circuitry 304 waits until it reaches the same location within one of its processing threads, and/or control circuitry waits by default for 1 second but may extend the wait if resources are limited), based on synchronous metadata (e.g., synchronous metadata indicates that something is happening in the program), and/or based on processing the video signal (e.g., a sudden black screen may indicate a large change in the program). The end of the wait may be signified by a software or hardware interrupt that wakes up another thread to continue with process 1200 and/or by control circuitry 304 reaching a particular location within one of its processing threads.

At step 1216, control circuitry 304 may determine if the object is still in the particular location of the second screen (e.g., screen 700). For example, as part of this step, control circuitry 304 may determine that object 504 has moved from area 706 to area 802. Control circuitry 304 may accomplish this by correlating an image of the object from the previous iteration of step 1208 with a current image of the second screen (e.g., by correlating area 704 with screen 800). Alternatively or in addition, control circuitry 304 may correlate an image of the entire second screen from the previous iteration of step 1208 with a current image of the entire second screen (e.g., by correlating screen 700 with screen 800). Correlating images of the entire screen may allow control circuitry 304 to calculate a change vector (i.e., a vector indicating the magnitude and direction of any shift in the view presented between screen 700 and screen 800). Alternatively or in addition, control circuitry 304 may retrieve a new location for the selected object from the synchronous metadata.

If control circuitry 304 determines that the object is no longer in the same location determined at step 1208, control circuitry 304 may return to step 1208 to identify a new particular location for the object within the second screen (e.g., area 802 of screen 800). This may involve performing the same processing discussed above in reference to step 1208, using the result of the determination performed at step 1216 as the new particular location, and/or adding the change vector calculated at step 1216 to the previously identified particular location.

If control circuitry 304 determines at step 1216 that the object is still in the same location of the second screen, control circuitry 304 proceeds to step 1218. At step 1218, control circuitry 304 determines whether any user input modifying the manner of marking the object was received. Such user input may include any of the user preferences for marking objects discussed in reference to step 1112 of FIG. 11. If control circuitry 304 determines that user preferences for marking the object were received, control circuitry returns to step 1212 and selects a new manner of marking the object that takes into account the received user preferences. Otherwise, control circuitry 304 proceeds to step 1220.

At step 1220, control circuitry 304 determines if the event in the program for which an attribute of the object was identified at step 1202 is still present. This may involve performing parts of the analysis performed at step 1202 to determine if any of the premises used to identify the attribute are still present. Accordingly, control circuitry 304 may check whether the synchronous metadata still indicates that the event is present and/or that the object still has the same attributes associated with it. Control circuitry 304 may also analyze the received video signal to determine whether the same actions are still being performed. For example, control circuitry 304 may analyze the video signal to determine whether a mouth of the selected object is still moving, thereby determining if the same dialogue is still happening. Even if the same event is still present, control circuitry 304 may also determine whether the identified attribute of the object relative to the event is still present. This may involve any of the processing discussed above in reference to determining whether the same event is still present. If control circuitry 304 determines that the same event is no longer present or that the object no longer has the same attribute relative to this event, control circuitry 304 may return to step 1202 and identify a new attribute of the object, either relative to this event or to a new event in the program. Otherwise, control circuitry 304 proceeds to step 1222.

If at step 1220 or 1216 control circuitry 304 determines that a drastic enough change in the video has occurred, control circuitry 304 may also directly proceed to step 1224. For example, if control circuitry 304 determines at either step 1220 or 1216 that the scene has completely change (e.g., correlating an image of the prior screen or prior area corresponding to the object does not result in any correlation value above a certain threshold, and/or the synchronous metadata indicates such a change in scene) or that an altogether new program is now starting (e.g., the current time and the received media guidance data indicate the start of a new program), control circuitry 304 may proceed to step 1224 to display a video of the current program or a new program without marking any objects. If step 1224 is reached in this manner, control circuitry 304 may or may not display an indication on either the first or the second screen with information identifying what has occurred (e.g., that control circuitry will no longer attempt to mark the user selected object) and/or why (e.g., because a new program is starting).

At step 1222, control circuitry 304 determines whether user input selecting a new object or cancelling the marking of the present object has been received. Such user input can be received at the first user equipment device (e.g., wireless user communications device 406), the second user equipment device (e.g., user television equipment 402), the user equipment device encompassing control circuitry 304, and/or any other user equipment device in communication with control circuitry 304. If control circuitry 304 determines that user input selecting a new object or cancelling the marking has been received, control circuitry 304 may proceed to step 1224. If step 1224 is reached in this manner, control circuitry might not cause any indication to be displayed and/or may return to step 1108 of FIG. 11 to identify a new object. Alternatively, control circuit may proceed to step 1108 of FIG. 11 to identify a new object while continuing to present the current object as marked on the second screen (i.e., without performing step 1124). If control circuitry 304 determines at step 1222 that no such user input has been received, control circuitry 304 may return to step 1214 and continue waiting.

Additionally or alternatively, if control circuitry determines at step 1222 that the object has been marked for longer than a predefined time period (e.g., 30 seconds), a program based time period (e.g., 15 seconds for football games, 30 seconds for movies), a context based time period (e.g., the time period is calculated based on how rapidly scenes are changing in a program with more changes indicating that a short time period should be used), and/or a user set time period (e.g., the user profile information indicates that markings should be displayed for 30 seconds), control circuitry 304 may also proceed to step 1224 and cause the video of the program to be presented on the second screen without marking any objects.

While FIG. 12 illustrates steps 1216, 1218, 1220, and 1222 occurring in this order, this is only one exemplary embodiment. Any other order of these steps can be implemented equally well.

It will be apparent to those of ordinary skill in the art that the systems and methods involved in the present application may be embodied in a computer program product that includes a computer usable and/or readable medium. For example, the media guidance application and/or any instructions for performing any of the embodiments discussed herein may be encoded on machine readable media. Machine readable media includes any media capable of storing data. The machine readable media may be transitory, including, but not limited to, propagating electrical or electromagnetic signals, or may be non-transitory including, but not limited to, volatile and non-volatile computer memory or storage devices such as a hard disk, floppy disk, USB drive, DVD, CD, media cards, register memory, processor caches, flash memory, Random Access Memory (“RAM”), etc.

It is understood that the various features, elements, or processes of the foregoing figures and description are interchangeable or combinable to realize or practice the implementations described herein. Those skilled in the art will appreciate that aspects of the application can be practiced by other than the described implementations, which are presented for purposes of illustration rather than of limitation, and the aspects are limited only by the claims which follow.

What is claimed is:

1. A method for marking user selected objects, the method comprising:
receiving a user selection of an area of a video of a program presented on a second screen;
identifying an object in the video that corresponds to the selected area of the second screen;
identifying an attribute of the object relative to an event in the program;
selecting a manner of marking the object on a first screen that is simultaneously presenting the video based on the identified attribute of the object; and
causing the object to be displayed on the first screen as marked using the selected manner of marking.

2. The method of claim 1, wherein the first screen is connected to a first user equipment device, wherein the user selection of the area of the screen is received over a network from a second user equipment device connected to the second screen, and wherein each of the second user equipment device and the first user equipment device is assigned a different address in the network.

3. The method of claim 1, wherein causing the object to be displayed as marked comprises one or more of:
causing a border of a particular color to be displayed around the object;
causing an indication having a particular shape to be displayed in a position of the first screen associated with the object; and
causing the object to be displayed using a particular color scheme.

4. The method of claim 3, wherein selecting the manner of marking the object comprises one or more of:
selecting the particular color from a plurality of colors;
selecting the particular shape from a plurality of shapes; and
selecting the particular color scheme from a plurality of color schemes.

5. The method of claim 1, wherein identifying the attribute of the object relative to the event in the program comprises identifying an action being performed by the object.

6. The method of claim 1, wherein identifying the attribute of the object comprises one or more of:
identifying the object as a speaker of a current line of dialogue;
identifying the object as a participant in a sporting event having possession of a piece of equipment associated with the sporting event;
identifying the object as a participant in a sporting event scoring a point; and
identifying the object as a participant in a sporting event that is within a particular region of a venue associated with the sporting event.

7. The method of claim 1, further comprising:
identifying, at a later point in time and without either one of a second user selection of the area of the video presented on the second screen and user selection of a different second area of the video presented on the second screen, a second attribute of the object relative to a second event in the program;
selecting a different second manner of marking the object on the first screen that is simultaneously presenting the video based on the identified second attribute of the object; and
causing the object to be displayed on the first screen as marked using the selected different second manner of marking.

8. The method of claim 1, further comprising:
determining, at a later point in time and without either one of a second user selection of the area of the video presented on the second screen and user selection of a different second area of the video presented on the second screen, that the object is located in the different second area of the video presented on the first screen;
determining that the identified attribute is still an attribute of the object relative to the event in the program at the later point in time; and
causing the object to be displayed in the different second area of the first screen using the selected manner of marking.

9. The method of claim 1, wherein receiving the user selection of the area of the video presented on the second screen comprises receiving a set of coordinates corresponding to a border that at least partially surrounds the area of the video presented on the second screen.

10. The method of claim 1, further comprising causing additional information associated with the object to be displayed on the first screen based on the identified attribute of the object.

11. A system for marking user selected objects, the system comprising:
storage circuitry configured to store a plurality of manners of marking; and
control circuitry configured to:
receive a user selection of an area of a video of a program presented on a second screen;
identify an object in the video that corresponds to the selected area of the second screen;
identify an attribute of the object relative to an event in the program;
select a manner of marking the object, from the plurality of manners or marking, on a first screen that is simultaneously presenting the video based on the identified attribute of the object; and
cause the object to be displayed on the first screen as marked using the selected manner of marking.

12. The system of claim 11, wherein the first screen is connected to a first user equipment device, wherein the user selection of the area of the screen is received over a network from a second user equipment device connected to the second screen, and wherein each of the second user equipment device and the first user equipment device is assigned a different address in the network.

13. The system of claim 11, wherein the control circuitry is configured to cause the object to be displayed as marked by being one or more of:
configured to cause a border of a particular color to be displayed around the object;
configured to cause an indication having a particular shape to be displayed in a position of the first screen associated with the object; and
configured to cause the object to be displayed using a particular color scheme.

14. The system of claim 13, wherein the control circuitry is configured to select the manner of marking the object by being one or more of:
configured to select the particular color from a plurality of colors;
configured to select the particular shape from a plurality of shapes; and
configured to select the particular color scheme from a plurality of color schemes.

15. The system of claim 11, wherein the control circuitry is configured to identify the attribute of the object relative to the event in the program by being configured to identify an action being performed by the object.

16. The system of claim 11, wherein the control circuitry is configured to identify the attribute of the object by being one or more of:
configured to identify the object as a speaker of a current line of dialogue;
configured to identify the object as a participant in a sporting event having possession of a piece of equipment associated with the sporting event;
configured to identify the object as a participant in a sporting event scoring a point; and
configured to identify the object as a participant in a sporting event that is within a particular region of a venue associated with the sporting event.

17. The system of claim 11, wherein the control circuitry is further configured to:
identify, at a later point in time and without either one of a second user selection of the area of the video presented on the second screen and user selection of a different second area of the video presented on the second screen, a second attribute of the object relative to a second event in the program;
select a different second manner of marking the object on the first screen that is simultaneously presenting the video based on the identified second attribute of the object; and
cause the object to be displayed on the first screen as marked using the selected different second manner of marking.

18. The system of claim 11, wherein the control circuitry is further configured to:
determine, at a later point in time and without either one of a second user selection of the area of the video presented on the second screen and user selection of a different second area of the video presented on the second screen, that the object is located in the different second area of the video presented on the first screen;
determine that the identified attribute is still an attribute of the object relative to the event in the program at the later point in time; and
cause the object to be displayed in the different second area of the first screen using the selected manner of marking.

19. The system of claim 11, wherein the control circuitry is configured to receive the user selection of the area of the video presented on the second screen by being configured to receive a set of coordinates corresponding to a border that at least partially surrounds the area of the video presented on the second screen.

20. The system of claim 11, wherein the control circuitry is further configured to cause additional information associated with the object to be displayed on the first screen based on the identified attribute of the object.

21-50. (canceled)
